(19) United States
(12) Patent Application Publication
(10) Pub. No.: US 2020/0028718 A1
(43) Pub. Date: Jan. 23, 2020

(54) REFERENCE SIGNAL TRANSMISSION METHOD, CHANNEL MEASUREMENT METHOD, RADIO BASE STATION AND USER TERMINAL

(71) Applicant: NTT DOCOMO, INC., Tokyo (JP)

(72) Inventors: Xin WANG, Beijing (CN); Chongning NA, Beijing (CN); Huiling JIANG, Beijing (CN); Yuichi KAKISHIMA, Tokyo (JP); Satoshi NAGATA, Tokyo (JP)

(73) Assignee: NTT DOCOMO, INC., Tokyo (JP)

(21) Appl. No.: 16/496,185

(22) PCT Filed: Mar. 22, 2018
(86) PCT No.: PCT/CN2018/079951

§ 371 Date: Sep. 20, 2019

(30) Foreign Application Priority Data
Mar. 23, 2017 (CN) 201710179455.8

(51) Int. Cl. H04L 25/02; H04L 5/00

(52) U.S. Cl. CPC H04L 25/0226; H04L 5/0048

(57) ABSTRACT

Provided in embodiments of the present invention are a reference signal transmission method, a channel measurement method, a radio base station and a user terminal. The reference signal transmission method performed by a radio base station according to the embodiments of the present invention includes: transmitting port indication information indicating measurement ports for resource elements in a common reference signal resource region, wherein one resource element in the common reference signal resource region is allocated with measuring ports corresponding to one or more channel measurement types; and transmitting reference information to a user terminal by using the resource elements in the common reference signal resource region.

### TECHNICAL FIELD

The present invention relates to a field of wireless communications, and in particular, to a resource determining method, a radio base station, and a user terminal that may be used in a wireless communication system.

### BACKGROUND

Methods of measuring multiple types of channels have been proposed, e.g. channel measurement based on non-zero power channel state information reference signals (CSI-RSs), and channel measurement based on zero power CSI-RSs. In addition, with the application of large-scale multiple-input multiple-output (MIMO) antennas, when the large-scale MIMO antennas are used, especially in the case of applying multi-user (MU) MIMO scheme for communication, compared to the traditional channel measurement based on CSI-RSs, interference suffered by data channels received by a user terminal may more accurately reflect channel quality of the user terminal. Therefore, channel measurement based on demodulation reference signals (DMRSs) is proposed.

However, in the current communication system, resource configuration needs to be respectively carried out for different channel measurement schemes, which results in low resource utilization efficiency and is not conducive to flexible use of resources.

### SUMMARY OF THE INVENTION

According to one aspect of the present invention, there is provided a reference signal transmission method performed by a radio base station, including: transmitting port indication information which indicates measurement ports for resource elements in a common reference signal resource region, wherein one resource element in the common reference signal resource region is allocated with measurement ports corresponding to one or more channel measurement types; transmitting reference information to a user terminal by using the resource elements in the common reference signal resource region.

According to another aspect of the present invention, there is provided a channel measurement method performed by a user terminal, including: receiving port indication information which indicates measurement ports for resource elements in a common reference signal resource region, wherein one resource element in the common reference signal resource region is allocated with measurement ports respectively corresponding to one or more channel measurement types; obtaining, according to the port indication information, reference information transmitted by the resource elements in the common reference signal resource region; processing the reference information according to channel measurement types corresponding to the measurement ports indicated by the port indication information.

According to another aspect of the present invention, there is provided a radio base station, including: a transmitting unit configured to transmit port indication information which indicates measurement ports for resource elements in a common reference signal resource region, wherein one resource element in the common reference signal resource region is allocated with measurement ports respectively corresponding to one or more channel measurement types, and a processing unit configured to indicate the transmitting unit to transmit reference information to a user terminal by using the resource elements in the common reference signal resource region.

According to another aspect of the present invention, there is provided a user terminal, including: a receiving unit configured to receive resource region indication information which indicates a common reference signal resource region, and to receive port indication information which indicates measurement ports for resource elements in the common reference signal resource region, wherein one resource element in the common reference signal resource region is allocated with measurement ports respectively corresponding to one or more channel measurement types; a processing unit configured to obtain, according to the resource region indication information and the port indication information, reference information transmitted by the resource elements in the common reference signal resource region, and to process the reference information according to channel measurement types corresponding to the measurement ports indicated by the port indication information.

In the reference signal transmission method, the channel measurement method, the radio base station, and the user terminal according to the above aspects of the present invention, a same common reference signal resource region is set for a plurality of channel measurement types, and one resource element in the common reference signal resource region is set measurement ports corresponding to one or more channel measurement types, such that the user terminal may process information transmitted by using the resource elements according to one or more channel measurement types corresponding to the measurement ports for the resource elements. In embodiments according to the present invention, information transmitted by using a same resource element may be used for a plurality of channel measurements. Therefore, the utilization of resources is effectively improved, and the flexibility of resource allocation is improved.

### BRIEF DESCRIPTION OF THE DRAWINGS

The above and other objects, features and advantages of the present disclosure will become clearer by describing embodiments of the present invention in detail with reference to the accompanying drawings.

FIG. 1 is a flow chart showing a reference signal transmission method performed by a radio base station according to one embodiment of the present invention.

FIG. 2 is a schematic diagram showing a common reference signal resource region in one time slot, according to one example of the present invention.

FIG. 3 is a schematic diagram showing measurement ports allocated to a part of resource elements in the common reference signal resource region shown in FIG. 2, according to one example of the present invention.

FIG. 4 is a flow chart showing a method of transmitting port indication information indicating measurement ports for the resource elements in the common reference signal resource region according to one example of the present invention.

FIG. 5 is a schematic diagram showing measurement ports allocated to a part of resource elements in the common reference signal resource region shown in FIG. 2, according to another example of the present invention.

FIG. 6 shows a flow chart of a channel measurement method performed by a user terminal according to embodiments of the present invention.

FIG. 7 shows a block diagram of the radio base station according to embodiments of the present invention.

FIG. 8 shows a block diagram of the user terminal according to embodiments of the present invention.

FIG. 9 is a diagram showing one example of a hardware configuration of the radio base station and the user terminal related to one implementation of the present invention.

FIG. 10 is a schematic diagram showing a range of resources where available for uplink or downlink is limited according to one example of the present invention.

FIG. 11 is a schematic diagram showing setting resources for the uplink scheduling resources as a part of the downlink scheduling resources according to one example of the present invention.

### DESCRIPTION OF THE EMBODIMENTS

A reference signal transmission method, a channel measurement method, a radio base station, and a user terminal according to embodiments of the present invention will be described below with reference to the accompanying drawings. Like reference numerals refer to like elements throughout the accompanying drawings. It should be understood that the embodiments described herein are merely illustrative and should not be constructed as limiting the scope of the present invention. In addition, the UE described herein may include various types of user terminals, for example, a mobile terminal or a fixed terminal. However, for convenience, the UE and the user terminal sometimes may be used interchangeably hereinafter.

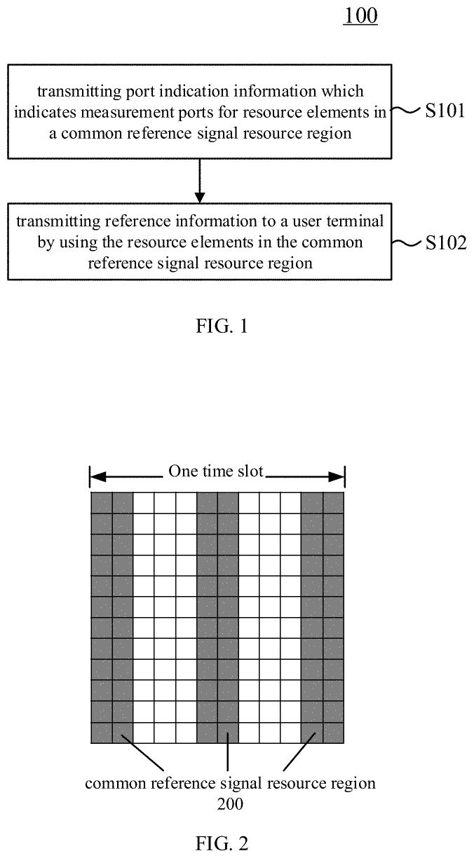

First, a reference signal transmission method performed by the radio base station according to one embodiment of the present invention will be described with reference to FIG. 1. FIG. 1 is a flow chart showing a reference signal transmission method 100 performed by the radio base station according to one embodiment of the present invention. As shown in FIG. 1, in step S101, port indication information which indicates measurement ports for resource elements in a common reference signal resource region is transmitted, where one resource element in the common reference signal resource region is allocated with measurement port(s) corresponding to one or more channel measurement types. According to one example of the present invention, in step S101, the radio base station may transmit, to respective user terminals, port indication information of the measurement ports of the resource elements for each terminal device.

FIG. 2 is a schematic diagram showing a common reference signal resource region 200 in one time slot according to one example of the present invention. In the example shown in FIG. 2, a gray area is the common reference signal resource region in one subframe. It should be noted that although the common reference signal resource region in one time slot is illustrated as an example in FIG. 2, the present invention is not limited thereto. For example, according to another example of the present invention, the common reference signal resource region may also be configured for a plurality of subframes.

According to one example of the present invention, the common reference signal resource region may be predetermined. Alternatively, the radio base station may also transmit signaling to the UE to inform of the common reference signal resource region in the cell. In particular, the method shown in FIG. 1 may also include transmitting resource region indication information indicating the common reference signal resource region. According to one example of the present invention, the radio base station may transmit the resource region indication information indicating the common reference signal resource region to the user equipment via high layer signaling. For example, the resource region indication information may be transmitted to the user equipment via control signaling of a Medium Access Control layer (MAC) or control signaling of a Radio Resource Control (RRC) or other control signaling of a protocol layer having a function of managing resources. In addition, according to another example of the present invention, the common reference signal resource region may be cell-specific, that is, respective UEs in the cell use the same common reference signal resource region.

In embodiments according to the present invention, the channel measurement types may include the types of the UE capable of carrying out various channel measurements. For example, the channel measurement types include channel measurement based on non-zero power CSI-RSs, channel measurement based on zero power CSI-RSs, and/or channel measurement based on DMRSs. However, the channel measurement types of the present invention are not limited thereto. For another example, the channel measurement types may also include channel measurement carried out based on phase tracking reference signals, or the like. In embodiments according to the present invention, the CSI-RS refers to a reference signal for measuring a channel state, which may include a channel state information reference signal that has been proposed in 3GPP standard, and may also include other reference signals having similar function. In addition, the DMRS refers to a reference signal for demodulation, which may include a demodulation reference signal that has been proposed in the 3GPP standard, and may also include other reference signals having similar function.

In addition, according to another example of the present invention, the measurement port(s) which are allocated to one resource element in the common reference signal resource region may have a one-to-one correspondence with the channel measurement types. Alternatively, one measurement port which is allocated to one resource element in the common reference signal resource region may correspond to a plurality of channel measurement types. For example, when information transmitted through the same resource element is to be used for the channel measurement based on CSI-RSs and the channel measurement based on DMRSs, the resource element may be allocated with a measurement port corresponding to the channel measurement based on CSI-RSs and a measurement port corresponding to the channel measurement based on DMRSs, respectively. For another example, the resource elements may also be allocated with one measurement port corresponding to both the channel measurement based on CSI-RSs and the channel measurement based on DMRSs.

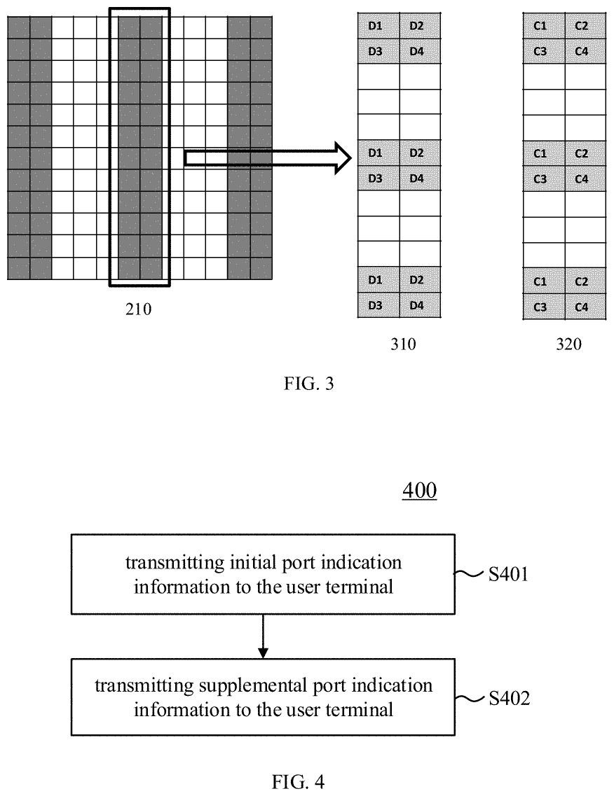

FIG. 3 is a schematic diagram showing measurement ports allocated to a part of resource elements 210 in the common reference signal resource region shown in FIG. 2, according to one example of the present invention. As shown in FIG. 3, some resource elements in the part of the resource elements 210 in the common reference signal resource region are allocated with measurement ports (as shown by the light gray areas in a resource port allocation chart 310 and a resource port allocation chart 320), and the rest resource elements are not used (as shown by the white areas in the resource port allocation chart 310 and the resource port allocation chart 320).

The resource port allocation chart 310 in FIG. 3 shows resource elements, to which measurement ports D1-D4 corresponding to the channel measurement based on DMRSs are allocated, in the part of resource elements 210 in the common reference signal resource region. The resource port allocation chart 320 in FIG. 3 shows resource element resource elements, to which measurement ports C1-C4 corresponding to the channel measurement based on CSI-RSs are allocated, in the part of resource elements 210 in the common reference signal resource region.

As shown in the resource port allocation chart 310 and the resource port allocation chart 320, in the example shown in FIG. 3, two measurement ports, that is, the measurement port corresponding to the channel measurement based on DMRSs and the measurement port corresponding to the channel measurement based on CSI-RSs, are allocated to the same resource element. That is, the information transmitted through the resource elements in the light gray areas of FIG. 3 will be used for both the channel measurement based on DMRSs and the channel measurement based on CSI-RSs. In particular, when the radio base station carries out Physical Downlink Shared Channel (PDSCH) transmission to the user terminal through the resource elements in the light gray areas, the information transmitted by the resource elements in the light gray areas is not only used as the DMRS and the data information to enable the UE to carry out the channel measurement based on DMRSs and the data demodulation, but also used as the CSI-RS to enable the UE to carry out the channel measurement based on CSI-RSs.

In addition, in step S101, the radio base station may transmit, at a time, port indication information indicating measurement ports which are allocated to the respective resource elements and correspond to the determined channel measurement types. Alternatively, in step S101, the radio base station may also transmit port indication information indicating measurement ports which are allocated to a part of resource elements and correspond to the determined channel measurement types, and set measurement ports for other part of the resource elements to be pending. The radio base station may then set the measurement ports for the other part of the resource elements as needed.

FIG. 4 is a flow chart showing a method of transmitting the port indication information indicating the measurement ports for the resource elements in the common reference signal resource region (that is, step S101) according to one example of the present invention.

As shown in FIG. 4, in step S401, initial port indication information is transmitted to the user terminal, where the initial port indication information indicates a first measurement port which is initially allocated to the resource elements and corresponds to specific channel measurement types, or a second measurement port which is initially allocated to the resource elements and corresponds to pending channel measurement types. According to one example of the present invention, in step S401, the radio base station may transmit the initial port indication information to the user equipment via high layer signaling, for example RRC layer signaling or MAC layer signaling, or other control signaling of the protocol layer having a function of managing resources.

Then, in step S402, supplemental port indication information is transmitted to the user terminal, where the supplemental port indication information indicates measurement type that is supplementally allocated to the second measurement port.

For example, when the user terminal is indicated to carry out channel measurement based on CSI-RSs, the supplemental port indication information may indicate that the measurement type that is supplementally allocated to the second measurement port is channel measurement based on non-zero power CSI-RSs or channel measurement based on zero power CSI-RSs. For another example, when downlink shared channel transmission is carried out to the user terminal, the supplemental port indication information may indicate that the second measurement port is supplementally allocated to the channel measurement based on DMRSs. When the downlink shared channel transmission is not carried out to the user terminal, the supplemental port indication information may indicate that the measurement type that is supplementally allocated to the second measurement port is the channel measurement based on non-zero power CSI-RSs or the channel measurement based on zero power CSI-RSs.

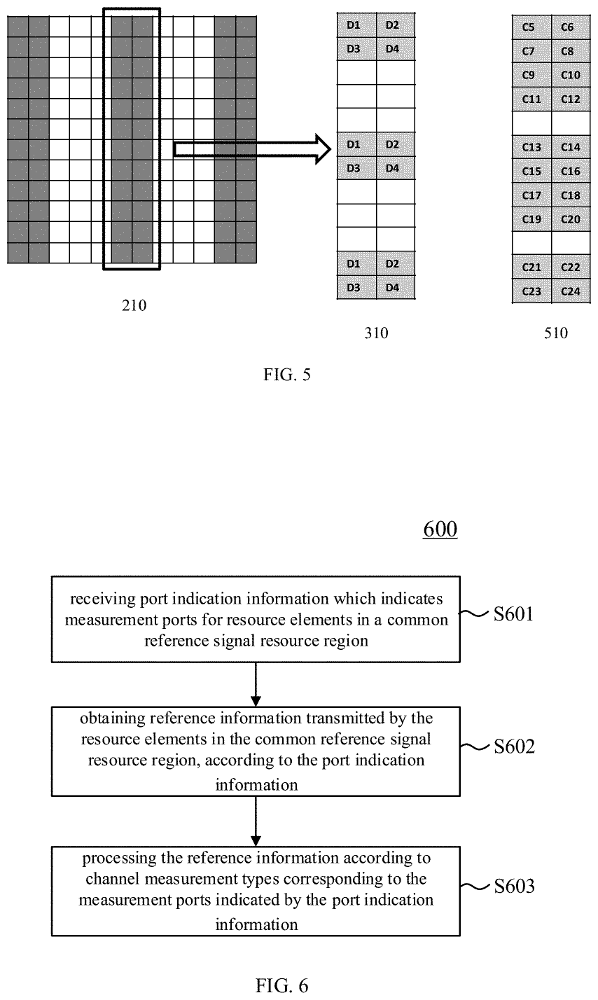

FIG. 5 is a schematic diagram showing the measurement ports allocated to a part of resource elements 210 in the common reference signal resource region shown in FIG. 2, according to another example of the present invention. According to the method shown in FIG. 4, as shown in FIG. 5, the measurement ports are allocated to some resource elements in the part of the resource elements 210 in the common reference signal resource region (as shown by the light gray areas in the resource port allocation chart 310 and a resource port allocation chart 510), and the rest resource elements are not used (as shown by the white areas in the resource port allocation chart 310 and the resource port allocation chart 510).

As shown in FIG. 5, the light gray areas in the resource port allocation chart 310 overlap with a part of the light gray areas in the resource port allocation chart 510. In the example shown in FIG. 5, the radio base station may transmit to the user terminal a second measurement port, which is initially allocated to the resource elements in the overlapping portion and corresponds to the pending channel measurement types. The radio base station then transmit the supplemental port indication information to the user terminal as needed, to indicate that the part of resource elements 210 are allocated with measurement ports D1-D4 corresponding to the channel measurement based on DMRSs (as shown by resource port allocation chart 310). Attentively, the radio base station may transmit the supplemental port indication information, so as to indicate that the part of resource elements 210 are allocated with measurement ports C5-C24 corresponding to the channel measurement based on CSI-RSs (as shown by resource port allocation chart 510).

For example, when the downlink shared channel transmission is carried out to the user terminal, the radio base station may transmit the supplemental port indication information, to indicate that measurement ports D1-D4 for the resource elements in the overlapping portion correspond to the channel measurement based on DMRSs. When the downlink shared channel transmission is not carried out to the user terminal, the radio base station may transmit the supplemental port indication information, to indicate that measurement ports C5-C8, C13-C16 and C21-C24 for resource elements in the overlapping portion correspond to the channel measurement based on non-zero power CSI-RSs or the channel measurement based on zero-power CSI-RSs.

In addition, optionally, when the downlink shared channel transmission is carried out to the user terminal, the supplemental port indication information may further indicate that the measurement ports for the resource elements in the overlapping portion also correspond to the channel measurement based on CSI-RSs, that is, indicate that the measurement ports for the resource elements in the overlapping portion are C1-C4 in FIG. 3. According to one example of the present invention, a density of channel measurement made by measurement ports C5-C24 may be lower than a density of channel measurement made by measurement ports D1-D4 and/or C1-C4.

In addition, in the example shown in FIG. 5, the initial port indication information may be used to indicate that measurement ports C9-C12 and C17-C20 corresponding to the channel measurement based on CSI-RSs are initially allocated to the resource elements in the light gray areas where the resource port allocation chart 510 does not overlap with the resource port allocation chart 310. For example, the initial port indication information may be used to indicate that measurement ports C9 and C10 correspond to the channel measurement based on zero power CSI-RSs.

Returning to FIG. 4, according to one example of the present invention, the method of FIG. 4 may also include transmitting port adjustment information to the user terminal to change the measurement type corresponding to the first measurement port. For example, in a case where the initial port indication information indicates that the measurement ports corresponding to the channel measurement based on zero-power CSI-RSs are initially allocated to one resource element, it may be changed to the measurement ports corresponding to the channel measurement based on non-zero power CSI-RSs through the port adjustment information, and vice versa.

In addition, according to another example of the present invention, in step S402, the radio base station may transmit the supplemental port indication information to the user equipment by, for example, physical layer signaling. And similarly, the port adjustment information may be transmitted to the user equipment by, for example, physical layer signaling.

For example, when transmitting signaling to the UE (for example, by transmitting uplink grant (UL grant) signaling) to indicate measurement and transmission uplink feedback, the radio base station may indicate the user terminal to carry out the channel measurement based on CSI-RSs via the signaling, and transmit the supplemental port indication information or the port adjustment information to the user equipment. For another example, when transmitting signaling to the UE to indicate downlink transmission, for example, when transmitting the downlink grant (DL grant) signaling, the radio base station may indicate the user terminal to carry out the channel measurement based on DMRSs via the signaling, and transmit the supplemental port indication information or the port adjustment information to the user equipment.

When carrying out both the uplink grant and the downlink grant to the UE, the radio base station may transmit the uplink grant signaling and the downlink grant signaling to the UE, respectively. Alternatively, in order to reduce signaling overhead and a complexity of transmission operation, the radio base station may transmit joint grant signaling including both the uplink grant and the downlink grant to the UE. The resource indication information for uplink scheduling resources and/or downlink scheduling resources of the user terminal is included in the uplink grant signaling, the downlink grant signaling, and the joint grant signaling.

In the joint grant signaling, the resource indication information may respectively indicate the uplink scheduling resources and the downlink scheduling resources for the user terminal. In addition, in order to further reduce signaling overhead, a range of available resources to uplink or downlink may be limited in advance to reduce a complexity of encoding the uplink or downlink grant resources.

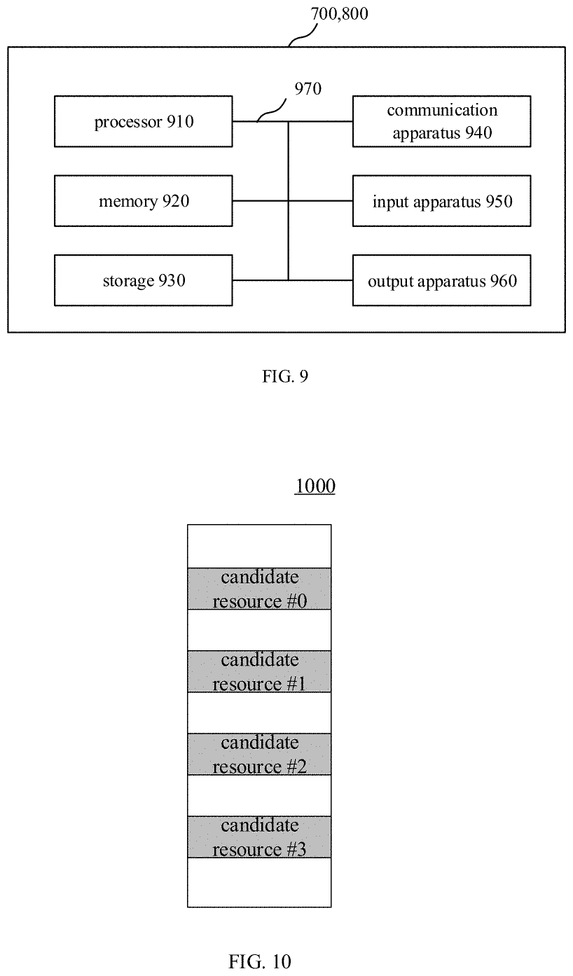

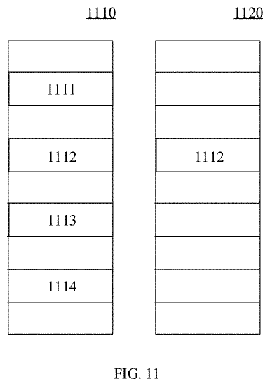

FIG. 10 is a schematic diagram showing the range of available resources to uplink or downlink being limited according to one example of the present invention. As shown in FIG. 10, in a conventional communication system, the available resources to uplink or downlink may be an entire sub-band 1000. In this case, it is necessary to indicate resources that are actually used by UE for uplink or downlink within a range of the entire sub-band 1000. In the examples according to the present invention, the available resources to uplink or downlink are preset as candidate resources #0-#4 shown in the gray areas in the sub-band 1000, thereby reducing the complexity of encoding the uplink or downlink grant resources.

Alternatively, in the joint grant signaling, resources for the uplink scheduling resources may be set as a part of resources for the downlink scheduling resources. Therefore, it is not necessary to indicate the range of the uplink scheduling resources in the entire resource pool. Instead, it only needs to indicate the uplink scheduling resource within the range of the downlink scheduling resources, thereby further reducing the signaling overhead.

FIG. 11 is a schematic diagram showing setting resources for the uplink scheduling resource as a part of resources for the downlink scheduling resources according to one example of the present invention. As shown in FIG. 11, the downlink scheduling resources that may be allocated to the user equipment are resource blocks 1111, 1112, 1113, and 1114, and the resource block 1112 therein is indicated for the uplink scheduling resources.

Returning to FIG. 1, in step S102, reference information is transmitted to the user terminal by using the resource elements in the common reference signal resource region. Therefore, the user terminal may carry out corresponding processing on the reference information transmitted by using the resource elements according to the port indication of the resource elements received in step S101.

In the reference signal transmission method according to the embodiments of the present invention described in connection with FIGS. 1-5, the user terminal is indicated to process the information transmitted by using the resource elements according to one or more channel measurement types corresponding to the measurement ports of the resource elements, by setting the same common reference signal resource for a plurality of channel measurement types and setting the measurement ports corresponding to one or more channel measurement types for one resource element in the common reference signal resource region. Therefore, it is not necessary to respectively set corresponding resources for different channel measurement types. Therefore, the utilization of resources is effectively improved, and the flexibility of resource configuration is improved.

Next, a channel measurement method performed by a user terminal according to embodiments of the present invention will be described with reference to FIG. 6. FIG. 6 shows a flow chart of a channel measurement method 600 performed by the user terminal according to the embodiments of the present invention.

As shown in FIG. 6, in step S601, port indication information which indicates measurement ports for resource elements in a common reference signal resource region is received, where one resource element in the common reference signal resource region is allocated with measurement port(s) respectively corresponding to one or more channel measurement types.

According to one example of the present invention, the common reference signal resource region may be predetermined. Alternatively, a radio base station may also transmit signaling to the UE to inform of the common reference signal resource region in the cell. In this case, the method 600 shown in FIG. 6 may also include receiving resource region indication information which indicates the common reference signal resource region.

The channel measurement types may include the types of the UE capable of carrying out various channel measurements. For example, the channel measurement types include channel measurement based on non-zero power CSI-RSs, channel measurement based on zero power CSI-RSs, and/or channel measurement based on DMRSs. However, the channel measurement types of the present invention are not limited thereto. For another example, the channel measurement types may also include channel measurement carried out based on phase tracking reference signals. In embodiments according to the present invention, the CSI-RS refers to a reference signal for measuring a channel state, which may include a channel state information reference signal that has been proposed in 3GPP standard, and may also include other reference signals having similar function. In addition, the DMRS refers to a reference signal for demodulation, which may include a demodulation reference signal that has been proposed in the 3GPP standard, and may also include other reference signals having similar function.

In step S602, reference information transmitted by the resource elements in the common reference signal resource region is obtained according to the port indication information. According to one example of the present invention, in a case that the resource region indication information indicating the common reference signal resource region transmitted from the radio base station is received, in step S602, the reference information transmitted by the resource elements in the common reference signal resource region is also obtained according to the resource region indication information.

In step S603, the reference information obtained in step S602 is processed according to channel measurement types corresponding to the measurement port indicated by the port indication information. According to the port indication information, the reference information transmitted through the resource elements in the common reference signal resource region may be used for one or more channel measurements. When the port indication information indicates that one resource element is allocated with measurement ports corresponding to a plurality of channel measurement types, the reference information is respectively processed according to respective channel measurement type corresponding to the measurement ports.

For example, in the example shown in FIG. 3, the port indication information transmitted by the radio base station is received according to step S601, where the port indication information may indicate that the resource elements in the light gray areas where a resource port allocation chart 310 overlaps with a resource port allocation chart 320 may not only be allocated with measurement ports C1-C4 corresponding to channel measurement based on CSI-RSs, but also allocated with measurement ports D1-D4 corresponding to channel measurement based on DMRSs. When the radio base station transmits through the resource elements in the light gray areas where the resource port allocation chart 310 overlaps with the resource port allocation chart 320, in step S603, according to measurement ports D1-D4, information transmitted by the resource elements in the overlapping light gray areas is used as DMRSs and data information, and the channel measurement based on DMRSs is carried out through the information transmitted by the resource elements in the light gray areas; and according to measurement ports C1-C4, the information transmitted by the resource elements in the overlapping light gray areas is also used as CSI-RSs, and the channel measurement based on CSI-RSs is carried out through the information transmitted by the resource elements in the light gray areas. That is, in step S603, according to measurement ports C1-C4 and D1-D4, the user terminal not only uses the information transmitted through the resource elements in the light gray areas of FIG. 3 as DMRSs and data information to enable the UE to carry out the channel measurement based on DMRSs and data demodulation, but also uses the information transmitted through the resource elements in the light gray areas of FIG. 3 as CSI-RSs to enable the UE to carry out the channel measurement based on CSI-RSs.

For another example, as described above, the radio base station may also transmit port indication information indicating measurement ports which are allocated to a part of resource elements and correspond to the determined channel measurement types, and set measurement ports for other part of the resource elements to be pending. The radio base station may then set the measurement ports for the other part of the resource elements as needed. In this case, initial port indication information and supplemental port indication information transmitted by the radio base station are received respectively in step S601, where the initial port indication information indicates that the resource elements are initially allocated, and where the supplemental port indication information indicates measurement type that is supplementally allocated to the second measurement port.

In step S603, the reference information obtained in step S602 may be processed according to the initial port indication information and the supplemental port indication information recently received in step S601.

For example, in the example shown in FIG. 5, when the supplemental port indication information transmitted by the radio base station is received in step S601, where the supplemental port indication information indicates that the measurement ports for the resource elements in the overlapping portion are measurement ports D1-D4 corresponding to the channel measurement based on DMRSs, in step S603, information transmitted through the resource elements in the overlapping light gray areas is used as DMRS and data information according to measurement ports D1-D4, and the channel measurement based on DMRSs is carried out through the information transmitted by the resource elements in the light gray areas of the resource port allocation chart 310.

On the other hand, when the initial port indication information transmitted by the radio base station is received, where the initial port indication information indicates that the measurement ports are measurement ports C9-C12 and C17-C20 corresponding to the channel measurement based on CSI-RSs, and the supplemental port indication information transmitted by the radio base station is received in step S601, where the supplemental port indication information indicates that the measurement ports for the resource elements in the overlapping portion are measurement ports C5-C8, C13-C16 and C21 corresponding to the channel measurement based on CSI-RSs, the channel measurement based on CSI-RSs is carried out through the information transmitted by the resource elements in the light gray areas of a resource port allocation chart 510.

In addition, according to another example of the present invention, the radio base station may adjust the measurement ports allocated to the resource element as needed. In this case, the method shown in FIG. 6 may also include receiving port adjustment information, and processing the reference information according to changed measurement type corresponding to the measurement ports indicated by the port adjustment information.

For example, in a case where the initial port indication information indicates that one resource element is initially allocated with the measurement ports corresponding to channel measurement based on zero-power CSI-RSs, it may be changed to the measurement ports corresponding to the channel measurement based on non-zero power CSI-RSs through the port adjustment information. In this case, in step S603, the user terminal may process the reference information transmitted by the resource element according to the measurement ports indicated by the port adjustment information and corresponding to the channel measurement based on non-zero power CSI-RSs.

In the channel measurement method performed by the user terminal according to the embodiments of the present invention described in connection with FIG. 6, the user terminal may process the information transmitted by using the resource elements according to one or more channel measurement types corresponding to the measurement ports of the resource elements, by setting the same common reference signal resource for a plurality of channel measurement types and setting the measurement ports corresponding to one or more channel measurement types for one resource element in the common reference signal resource region. Thus, information transmitted by using the same resource element may be used for a plurality of channel measurements. Therefore, the utilization of resources is effectively improved, and the flexibility of resource configuration is improved.

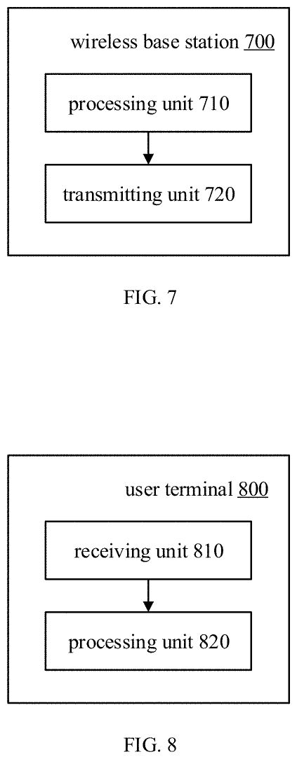

Next, a radio base station according to embodiments of the present invention will be described with reference to FIG. 7. FIG. 7 shows a block diagram of a radio base station 700 according to embodiments of the present invention. As shown in FIG. 7, the radio base station 700 includes a transmitting unit 710 and a processing unit 720. The radio base station 700 may include other components in addition to these two units. However, since these components are not related to the content of the embodiments of the present invention, the illustration and description thereof are omitted herein. In addition, since specific details of operations described below performed by the radio base station 700 according to the embodiments of the present invention are the same as those described above with reference to FIGS. 1-5, the repeated description of the same details is omitted herein to avoid repetition.

The transmitting unit 710 may transmit port indication information which indicates measurement ports for resource elements in a common reference signal resource region, where one resource element in the common reference signal resource region is allocated with measurement port(s) corresponding to one or more channel measurement types. According to one example of the present invention, the transmitting unit 710 may transmit, to respective user terminals, port indication information of the measurement ports of the resource elements for each terminal device.

In addition, according to another example of the present invention, the common reference signal resource region may be predetermined. Alternatively, the transmitting unit 710 may also transmit signaling to the UE to inform of the common reference signal resource region in the cell. In particular, the transmitting unit 710 may also transmit resource region indication information indicating the common reference signal resource region. According to one example of the present invention, the transmitting unit 710 may transmit the resource region indication information indicating the common reference signal resource region to the user equipment via high layer signaling. For example, the resource region indication information may be transmitted to the user equipment via signaling of the RRC layer or the MAC layer, or other control signaling of a protocol layer having a function of managing resources. In addition, according to another example of the present invention, the common reference signal resource region may be cell-specific, that is, respective UEs in the cell use the same common reference signal resource region.

In embodiments according to the present invention, the channel measurement types may include the types of the UE capable of carrying out various channel measurements. For example, the channel measurement types include channel measurement based on non-zero power CSI-RSs, channel measurement based on zero power CSI-RSs, and/or channel measurement based on DMRSs. However, the channel measurement types of the present invention are not limited thereto. For another example, the channel measurement types may also include channel measurement carried out based on phase tracking reference signals, or the like. In embodiments according to the present invention, the CSI-RS refers to a reference signal for measuring a channel state, which may include a channel state information reference signal that has been proposed in 3GPP standard, and may also include other reference signals having similar function. In addition, the DMRS refers to a reference signal for demodulation, which may include a demodulation reference signal that has been proposed in the 3GPP standard, and may also include other reference signals having similar function.

In addition, according to another example of the present invention, the measurement port(s) which are allocated to one resource element in the common reference signal resource region may have a one-to-one correspondence with the channel measurement types. Alternatively, one measurement port which is allocated to one resource element in the common reference signal resource region may correspond to a plurality of channel measurement types. For example, when information transmitted through the same resource element is to be used for the channel measurement based on CSI-RSs and the channel measurement based on DMRSs, the resource element may be allocated with a measurement port corresponding to the channel measurement based on CSI-RSs and a measurement port corresponding to the channel measurement based on DMRSs, respectively. For another example, the resource elements may also be allocated with one measurement port corresponding to both the channel measurement based on CSI-RSs and the channel measurement based on DMRSs.

In addition, when a measurement port which is allocated to one resource element is allocated with measurement ports that may correspond to a plurality of channel measurement types, the transmitting unit 710 transmits information through the resource element to be used to perform respective channel measurements corresponding to the measurement ports. For example, when one resource element is not only allocated with measurement ports corresponding to the channel measurement based on CSI-RSs, but also allocated with measurement ports corresponding to the channel measurement based on DMRSs, information transmitted through resource elements in light gray areas is not only used as DMRS and data information to enable the UE to carry out the channel measurement based on DMRSs and data demodulation, but also as CSI-RSs to enable the UE to carry out the channel measurement based on CSI-RSs.

In addition, the transmitting unit 710 may transmit, at a time, port indication information indicating measurement ports which are allocated to the respective resource elements and correspond to the determined channel measurement types. Alternatively, the transmitting unit 710 may also transmit port indication information indicating measurement ports which are allocated to a part of resource elements and correspond to the determined channel measurement types, and set measurement ports for other part of the resource elements to be pending. The radio base station may then set the measurement ports for the other part of the resource elements as needed.

In particular, the transmitting unit 710 may transmit initial port indication information to the user terminal, where the initial port indication information indicates a first measurement port which is initially allocated to the resource elements and corresponds to specific channel measurement types, or a second measurement port which is initially allocated to the resource elements and corresponds to pending channel measurement types. According to one example of the present invention, the transmitting unit 710 may transmit the initial port indication information to the user equipment via high layer signaling, for example RRC layer signaling or MAC layer signaling, or other control signaling of the protocol layer having a function of managing resources.

Then, the transmitting unit 710 may transmit supplemental port indication information to the user terminal, where the supplemental port indication information indicates measurement type that is supplementally allocated to the second measurement port.

For example, when the user terminal is indicated to carry out channel measurement based on CSI-RSs, the transmitting unit 710 may transmit the supplemental port indication information to indicate that the measurement type that is supplementally allocated to the second measurement port is channel measurement based on non-zero power CSI-RSs or channel measurement based on zero power CSI-RSs. For another example, when downlink shared channel transmission is carried out to the user terminal, the transmitting unit 710 may transmit the supplemental port indication information to indicate to supplementally allocate the channel measurement based on DMRSs to the second measurement port. In addition, when the downlink shared channel transmission is not carried out to the user terminal, the transmitting unit 710 may also transmit the supplemental port indication information to indicate that the measurement type that is supplementally allocated to the second measurement port is the channel measurement based on non-zero power CSI-RSs or the channel measurement based on zero power CSI-RSs.

In addition, according to another example of the present invention, the transmitting unit 710 may also transmit port adjustment information to the user terminal to change the measurement type corresponding to the first measurement port. For example, in a case where the initial port indication information indicates that the measurement ports corresponding to the channel measurement based on the zero-power CSI-RSs are initially allocated to one resource element, the transmitting unit 710 may transmit the port adjustment information to change it to the measurement ports corresponding to the channel measurement based on non-zero power CSI-RSs, and vice versa.

In addition, according to another example of the present invention, the transmitting unit 710 may transmit supplemental port indication information to the user equipment by, for example, physical layer signaling. And similarly, the transmitting unit 710 may transmit the port adjustment information to the user equipment by, for example, physical layer signaling.

For example, when transmitting signaling to the UE (for example, by transmitting uplink grant (UL grant) signaling) to indicate measurement and transmission uplink feedback, the transmitting unit 710 may indicate the user terminal to carry out the channel measurement based on CSI-RSs via the signaling, and transmit the supplemental port indication information or the port adjustment information to the user equipment. For another example, when transmitting signaling to the UE to indicate downlink transmission, for example, when transmitting the downlink grant (DL grant) signaling, the transmitting unit 710 may indicate the user terminal to carry out the channel measurement based on DMRSs via the signaling, and transmit the supplemental port indication information or the port adjustment information to the user equipment.

When the radio base station carries out both the uplink grant and the downlink grant to the UE, the transmitting unit 710 may transmit the uplink grant signaling and the downlink grant signaling to the UE, respectively. Alternatively, in order to reduce signaling overhead and a complexity of transmission operation, the transmitting unit 710 may transmit joint grant signaling including both the uplink grant and the downlink grant to the UE. The resource indication information for uplink scheduling resources and/or downlink scheduling resources of the user terminal is included in the uplink grant signaling, the downlink grant signaling, and the joint grant signaling.

In the joint grant signaling, the resource indication information may respectively indicate the uplink scheduling resources and the downlink scheduling resources for the user terminal. In addition, in order to further reduce signaling overhead, a range of available resources to uplink or downlink may be limited in advance to reduce a complexity of encoding the uplink or downlink grant resources.

Alternatively, in the joint grant signaling, resources for the uplink scheduling resources may be set as a part of resources for the downlink scheduling resources. Therefore, it is not necessary to indicate the range of the uplink scheduling resources in the entire resource pool. Instead, it only needs to indicate the uplink scheduling resource within the range of the downlink scheduling resources, thereby further reducing the signaling overhead.

Then, the processing unit 720 indicates the transmitting unit to transmit reference information to the user terminal by using the resource elements in the common reference signal resource region. Therefore, the user terminal may carry out corresponding processing on the reference information transmitted by using the resource elements according to the port indication of the received resource element.

In the radio base station according to the embodiments of the present invention described in connection with FIG. 7, the user terminal is indicated to process the information transmitted by using the resource elements according to one or more channel measurement types corresponding to the measurement ports of the resource elements, by setting the same common reference signal resource for a plurality of channel measurement types and setting the measurement ports corresponding to one or more channel measurement types for one resource element in the common reference signal resource region. Therefore, it is not necessary to respectively set corresponding resources for different channel measurement types. Therefore, the utilization of resources is effectively improved, and the flexibility of resource configuration is improved.

Next, a user terminal according to embodiments of the present invention will be described with reference to FIG. 8. FIG. 8 shows a block diagram of a user terminal 800 according to embodiments of the present invention. As shown in FIG. 8, the user terminal 800 includes a receiving unit 810 and a processing unit 820. The user terminal 800 may include other components in addition to these two units. However, since these components are not related to the content of the embodiments of the present invention, illustration and description thereof are omitted herein. In addition, since the specific details of operations described below performed by the user terminal 800 according to the embodiments of the present invention are the same as those described above with reference to FIG. 6, repeated description of the same details is omitted herein to avoid repetition.

The receiving unit 810 receives port indication information which indicates measurement ports for resource elements in a common reference signal resource region, one resource element in the common reference signal resource region is allocated with measurement port(s) respectively corresponding to one or more channel measurement types.

According to one example of the present invention, the common reference signal resource region may be predetermined. Alternatively, a radio base station may also transmit signaling to the UE to inform of the common reference signal resource region in the cell. In this case, the receiving unit 810 may also receive resource region indication information which indicates the common reference signal resource region.

The channel measurement types may include the types of the UE capable of carrying out various channel measurements. For example, the channel measurement types include channel measurement based on non-zero power CSI-RSs, channel measurement based on zero power CSI-RSs, and/or channel measurement based on DMRSs. However, the channel measurement types of the present invention are not limited thereto. For another example, the channel measurement types may also include channel measurement carried out based on phase tracking reference signal. In embodiments according to the present invention, the CSI-RS refers to a reference signal for measuring a channel state, which may include a channel state information reference signal that has been proposed in 3GPP standard, and may also include other reference signals having similar function. In addition, the DMRS refers to a reference signal for demodulation, which may include a demodulation reference signal that has been proposed in the 3GPP standard, and may also include other reference signals having similar function.

The processing unit 820 may obtain reference information transmitted by the resource elements in the common reference signal resource region according to the port indication information. According to one example of the present invention, in a case that the resource region indication information indicating the common reference signal resource region transmitted from the radio base station is received, the processing unit 820 may also obtain, the reference information transmitted by the resource element in the common reference signal resource region according to the resource region indication information.

In addition, the processing unit 820 may also process the obtained reference information according to channel measurement types corresponding to the measurement port indicated by the port indication information. According to the port indication information, the reference information transmitted through the resource elements in the common reference signal resource region may be used for one or more channel measurements. When the port indication information indicates that one resource element is allocated with measurement ports corresponding to a plurality of channel measurement types, the reference information is respectively processed according to respective channel measurement type corresponding to the measurement ports.

For example, in the example shown in FIG. 3, the receiving unit 810 receives the port indication information transmitted by the radio base station, where the port indication information may indicate that the resource elements in the light gray areas in which a resource port allocation chart 310 overlaps with a resource port allocation chart 320 may not only be allocated with measurement ports C1-C4 corresponding to channel measurement based on CSI-RSs, but also allocated with measurement ports D1-D4 corresponding to channel measurement based on DMRSs. When the radio base station transmits through the resource elements in the light gray areas where the resource port allocation chart 310 overlaps with the resource port allocation chart 320, the processing unit 830 uses information transmitted by the resource elements in the overlapping light gray areas as DMRS and data information, and carries out the channel measurement based on DMRSs through the information transmitted by the resource elements in the light gray areas according to measurement ports D1-D4; and also uses the information transmitted by the resource elements in the overlapping light gray areas as CSI-RSs, and carries out the channel measurement based on CSI-RSs through the information transmitted by the resource elements in the light gray areas according to measurement ports C1-C4. That is, according to measurement ports C1-C4 and D1-D4, the processing unit 830 not only uses the information transmitted through the resource elements in the light gray areas of FIG. 3 as DMRS and data information to enable the UE to carry out the channel measurement based on DMRSs and data demodulation, but also uses the information transmitted through the resource elements in the light gray areas of FIG. 3 as the CSI-RSs to enable the UE to carry out the channel measurement based on CSI-RSs.

For another example, as described above, the radio base station may also transmit port indication information indicating measurement ports which are allocated to a part of resource elements and correspond to the determined channel measurement types, and set measurement ports for other part of the resource elements to be pending. The radio base station may then set the measurement ports for the other part of the resource elements as needed. In this case, the receiving unit 810 may respectively receive initial port indication information and supplemental port indication information transmitted by the radio base station, where the initial port indication information indicates that the resource elements are initially allocated, and where the supplemental port indication information indicates measurement type that is supplementally allocated to the second measurement port.

The processing unit 830 may process the obtained reference information according to the initial port indication information and the supplemental port indication information recently received by the receiving unit 810.

For example, in the example shown in FIG. 5, when the receiving unit 810 receives the supplemental port indication information transmitted by the radio base station, where the supplemental port indication information indicates that the measurement ports for the resource elements in the overlapping portion are measurement ports D1-D4 corresponding to the channel measurement based on DMRSs, the processing unit 830 uses information transmitted through the resource elements in the overlapping light gray areas as DMRS and data information according to measurement ports D1-D4, and carries out the channel measurement based on DMRSs through the information transmitted by the resource elements in the light gray areas of the resource port allocation chart 310.

On the other hand, when the receiving unit 810 receives the initial port indication information transmitted by the radio base station, where the initial port indication information indicates that the measurement ports are measurement ports C9-C12 and C17-C20 corresponding to the channel measurement based on CSI-RSs, and receives the supplemental port indication information transmitted by the radio base station, where the supplemental port indication information indicates that the measurement ports for the resource elements in the overlapping portion are measurement ports C5-C8, C13-C16 and C21 corresponding to the channel measurement based on CSI-RSs, the receiving unit 810 carries out the channel measurement based on CSI-RSs through the information transmitted by the resource elements in the light gray areas of a resource port allocation chart 510.

In addition, according to another example of the present invention, the radio base station may adjust the measurement ports allocated to the resource element as needed. In this case, the receiving unit 810 may also receive port adjustment information, and process the reference information according to the changed measurement type corresponding to the measurement ports indicated by the port adjustment information.

For example, in a case where the initial port indication information indicates that one resource element is initially allocated with the measurement ports corresponding to a channel measurement based on zero-power CSI-RSs, it may be changed to the measurement ports corresponding to the channel measurement based on non-zero power CSI-RSs through the port adjustment information. In this case, the processing unit 830 may process the reference information transmitted by the resource element according to the measurement ports indicated by the port adjustment information and corresponding to the channel measurement based on the non-zero power CSI-RS.

In the user terminal according to the embodiments of the present invention described in connection with FIG. 8, the user terminal may process the information transmitted by using the resource elements according to one or more channel measurement types corresponding to the measurement ports of the resource elements, by setting the same common reference signal resource for a plurality of channel measurement types and setting the measurement ports corresponding to one or more channel measurement types for one resource element in the common reference signal resource region. Thus, information transmitted by using the same resource element may be used for a plurality of channel measurements. Therefore, the utilization of resources is effectively improved, and the flexibility of resource configuration is improved.

(Hardware Structure)

The radio base station, user terminals and so on in one embodiment of the present invention may function as a computer that executes the processes of the wireless communication method of the present invention. FIG. 9 is a diagram that shows an example of a hardware structure of the radio base station and user terminal according to one implementation of the present invention. The above described radio base station 700 and user terminal 800 may be physically designed as a computer apparatus including a processor 910, a storage 920, a memory 930, a communication apparatus 940, an input apparatus 950, an output apparatus 960, and a bus 970 and the like.

Moreover, in the following description, the word “apparatus” may be replaced by “circuit”, “device”, “unit” and so on. The hardware structure of a radio base station 700 and user terminal 800 may be designed to include one or more of each apparatus shown in the drawings, or may be designed not to include part of the apparatus.

For example, although only one processor 910 is shown, a plurality of processors may be provided. Furthermore, processes may be implemented with one processor, or processes may be implemented either simultaneously or in sequence, or in different manners, on two or more processors. It should be noted that the processor 910 may be implemented with one or more chips.

Each function of the radio base station 700 and user terminal 800 is implemented by reading predetermined software (program) on hardware such as the processor 910 and the memory 920, so as to make the processor 910 perform calculations, and by controlling the communication carried out by the communication apparatus 940, and the reading and/or writing of data in the memory 920 and the storage 930.

The processor 910 may control the whole computer by, for example, running an operating system. The processor 910 may be configured with a central processing unit (CPU), which includes interfaces with peripheral apparatus, control apparatus, computing apparatus, a register and so on. For example, the above-described baseband signal processing section 104 (204), call processing section 105 and so on may be implemented by the processor 910.

Furthermore, the processor 910 reads programs (program codes), software modules or data, from the storage 930 and/or the communication apparatus 940, into the memory 920, and executes various processes according to these. As for the programs, programs to allow computers to execute at least part of the operations of the above-described embodiments may be used.

The memory 920 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 920 may be referred to as a “register”, a “cache”, a “main memory” (primary storage apparatus) and so on. The memory 920 can store executable programs (program codes), software modules and so on for implementing the wireless communication methods according to embodiments of the present invention.

The storage 930 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 930 may be referred to as “secondary storage apparatus.”

The communication apparatus 940 is hardware (transmitting/receiving device) for allowing inter-computer communication by using wired and/or wireless networks, and may be referred to as, for example, a “network device”, a “network controller”, a “network card”, a “communication module” and so on. The communication apparatus 940 may be configured to include a high frequency switch, a duplexer, a filter, a frequency synthesizer and so on in order to realize, for example, frequency division duplex (FDD) and/or time division duplex (TDD). For example, the above-described transmitting element 710, receiving elements 810 and so on may be implemented by the communication apparatus 940.

The input apparatus 950 is an input device for receiving input from the outside (for example, a keyboard, a mouse, a microphone, a switch, a button, a sensor and so on). The output apparatus 960 is an output device for allowing sending output to the outside (for example, a display, a speaker, an LED (Light Emitting Diode) lamp and so on). It should be noted that the input apparatus 950 and the output apparatus 960 may be provided in an integrated structure (for example, a touch panel).

Furthermore, these pieces of apparatus, including the processor 910, the memory 920 and so on are connected by the bus 970 so as to communicate information. The bus 970 may be formed with a single bus, or may be formed with buses that vary between pieces of apparatus.

Also, the radio base station 700 and user terminal 800 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 910 may be installed with at least one of these pieces of hardware.

(Variations)

Moreover, the terms illustrated in the present specification and/or the terms required for the understanding of the present specification may be substituted with terms having the same or similar meaning. For example, a channel and/or a symbol may be a signal. In addition, the signal may be a message. A reference signal may be abbreviated as an “RS (Reference Signal)”, and may be referred to as a “pilot”, a “pilot signal” and so on, depending on which standard applies. In addition, a component carrier (CC) may be referred to as a carrier frequency, a cell, or the like.

In addition, the wireless frame may be composed of one or more periods (frames) in the time domain. Each of the one or more periods (frames) constituting the wireless frame may also be referred to as a subframe. Further, a subframe may be composed of one or more slots in the time domain. The subframe may be a fixed length of time duration (eg, 1 ms) that is independent of the numerology.

Furthermore, a slot may be comprised of one or more symbols in the time domain (OFDM (Orthogonal Frequency Division Multiplexing) symbols, SC-FDMA (Single Carrier Frequency Division Multiple Access) symbols, and so on). Furthermore, the slot may also be a time unit configured based on parameter. Furthermore, a slot may also include multiple microslots. Each microslot may be comprised of one or more symbols in the time domain. Furthermore, a microslot may also be referred as “a subframe”.

A wireless frame, a subframe, a slot, a microslot and a symbol all represent the time unit when transmitting signals. A wireless frame, a subframe, a slot, a microslot and a symbol may also use other names that correspond to each other. For example, one subframe may be referred to as a “transmission time interval (TTI)”, and a plurality of consecutive subframes may also be referred to as a “TTI”, and one slot or one microslot may also be referred to as a “TTI.” That is, a subframe and/or a TTI may be a subframe (1 ms) in existing LTE, may be a shorter period than 1 ms (for example, one to thirteen symbols), or may be a longer period of time than 1 ms. It should be noted that a unit indicating a TTI may also be referred to as a slot, a microslot, or the like instead of a subframe.

Here, a TTI refers to the minimum time unit of scheduling in wireless communication, for example. For example, in LTE systems, a radio base station schedules the wireless resources (such as the frequency bandwidth and transmission power that can be used in each user terminal) to allocate to each user terminal in TTI units. It should be noted that the definition of TTIs is not limited to this.

TTIs may be channel-coded data packets (transport blocks), code blocks, and/or codeword transmission time units, or may be the unit of processing in scheduling, link adaptation and so on. It should be noted that, when a TTI is given, the time interval (e.g., the number of symbols) actually mapped to the transport block, code block, and/or codeword may also be shorter than the TTI.

Moreover, when one slot or one microslot is called a TTI, more than one TTI (i.e., more than one slot or more than one microslot) may also become the scheduled minimum time unit. Furthermore, the number of slots (the number of microslots) constituting the minimum time unit of the scheduling may be controlled.

A TTI having a time duration of 1 ms may be referred to as a “normal TTI” (TTI in LTE Rel. 8 to 12), a “standard TTI”, a “long TTI”, a “normal subframe”, a “standard subframe”, or a “long subframe”, and so on. A TTI that is shorter than a normal TTI may be referred to as a “shortened TTI”, a “short TTI”, a “partial (or fractional) TTI”, a “shortened subframe”, a “short subframe”, a “microslot”, or a “short microslot” and so on.

Moreover, a long TTI (eg, a normal TTI, a subframe, etc.) may be replaced with a TTI having a time duration exceeding 1 ms, and a short TTI (eg, a shortened TTI, and so on) may also be replaced with a TTI having a TTI duration shorter than the long TTI and a TTI duration exceeding 1 ms.

A resource block (RB) is the unit of resource allocation in the time domain and the frequency domain, and may include one or a plurality of consecutive subcarriers in the frequency domain. Also, an RB may include one or more symbols in the time domain, and may be one slot, one microslot, one subframe or one TTI duration. One TTI and one subframe each may be comprised of one or more resource blocks, respectively. It should be noted that one or more RBs may also be referred to as a “physical resource block (PRB (Physical RB))”, a “Sub-Carrier Group (SCG)”, a “Resource Element Group (REG)”, a “PRG pair”, an “RB pair” and so on.

Also, a resource block may also be composed of one or more resource elements (RE). For example, one RE can be a wireless resource area of a subcarrier and a symbol.

Moreover, the above-described structures of wireless frames, subframes, slots, microslots and symbols and so on are simply examples. For example, configurations such as the number of subframes included in a wireless frame, the number of slots of each subframe or wireless frame, the number or microslots included in a slot, the number of symbols and RBs included in a slot or microslot, the number of subcarriers included in an RB, the number of symbols in a TTI, the symbol duration and the cyclic prefix (CP) duration can be variously changed.

Also, the information and parameters and so on described in this specification may be represented in absolute values or in relative values with respect to predetermined values, or may be represented in corresponding other information. For example, wireless resources may be indicated by predetermined indices. In addition, equations to use these parameters and so on may be used, apart from those explicitly disclosed in this specification.

The names used for parameters and so on in this specification are not limited in any respect. For example, since various channels (PUCCH (Physical Uplink Control Channel), PDCCH (Physical Downlink Control Channel) and so on) and information elements can be identified by any suitable names, the various names assigned to these various channels and information elements are not limited in any respect.

The information, signals and so on described in this specification may be represented by using any one of various different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals and so on may be input and/or output via a plurality of network nodes.

The information, signals and so on that are input and/or output may be stored in a specific location (for example, in a memory), or may be managed in a control table. The information, signals and so on that are input and/or output may be overwritten, updated or appended. The information, signals and so on that are output may be deleted. The information, signals and so on that are input may be transmitted to other apparatus.

Reporting of information is by no means limited to the aspects/embodiments described in this specification, and other methods may be used as well. For example, reporting of information may be implemented by using physical layer signaling (for example, downlink control information (DCI), uplink control information (UCI)), higher layer signaling (for example, RRC (Wireless Resource Control) signaling, broadcast information (the master information block (MIB), system information blocks (SIBS) and so on), MAC (Medium Access Control) signaling and so on), and other signals and/or combinations of these.

Moreover, physical layer signaling may also be referred to as L1/L2 (Layer 1/Layer 2) control information (L1/L2 control signals), L1 control information (L1 control signal) and so on. Also, RRC signaling may be referred to as “RRC messages”, and can be, for example, an RRC connection setup message, RRC connection reconfiguration message, and so on. Also, MAC signaling may be reported using, for example, MAC control elements (MAC CEs (Control Elements)).

Also, reporting of predetermined information (for example, reporting of “X holds”) does not necessarily have to be carried out explicitly, and can be carried out implicitly (by, for example, not reporting this piece of information, or by reporting a different piece of information).

Regarding decisions, which may be made in values represented by one bit (0 or 1), may be made by a true or false value (Boolean value) represented by true or false, or may be made by comparing numerical values (for example, comparison against a predetermined value).

Software, whether referred to as “software”, “firmware”, “middleware”, “microcode” or “hardware description language”, or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are included in the definition of communication media.

The terms “system” and “network” as used herein are used interchangeably.

In the present specification, the terms “radio base station (BS)”, “radio base station”, “eNB”, “gNB”, “cell”, “sector”, “cell group”, “carrier” and “component carrier” may be used interchangeably. A base station may be referred to as a “fixed station”, “NodeB”, “eNodeB (eNB)”, “access point”, “transmission point”, “receiving point”, “femto cell”, “small cell” and so on.

A radio base station can accommodate one or more (for example, three) cells (also referred to as “sectors”). When a radio base station accommodates a plurality of cells, the entire coverage area of the radio base station can be partitioned into multiple smaller areas, and each smaller area can provide communication services through radio base station subsystems (for example, indoor small radio base stations (RRHs (Remote Wireless Heads))). The term “cell” or “sector” refers to part or all of the coverage area of a radio base station and/or a radio base station subsystem that provides communication services within this coverage.

In the present specification, the terms “mobile station (MS)”, “user terminal”, “user equipment (UE)” and “terminal” may be used interchangeably. A radio base station may be referred to as a “fixed station”, “NodeB”, “eNodeB (eNB)”, “access point”, “transmission point”, “receiving point”, “femto cell”, “small cell” and so on.

A mobile station is also sometimes used by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

Furthermore, the radio base stations in this specification may be interpreted as user terminals. For example, each aspect/embodiment of the present invention may be applied to a configuration in which communication between a radio base station and a user terminal is replaced with communication among a plurality of user terminals (D2D (Device-to-Device)). In this case, user terminals 800 may have the functions of the radio base stations 700 described above. In addition, terms such as “uplink” and “downlink” may be interpreted as “side.” For example, an uplink channel may be interpreted as a side channel.

Likewise, the user terminals in this specification may be interpreted as radio base stations. In this case, the radio base stations 700 may have the functions of the user terminals 800 described above.

In the present specification, it is assumed that certain actions to be performed by radio base station may, in some cases, be performed by its higher node (upper node). In a network comprised of one or more network nodes with radio base stations, it is clear that various operations that are performed to communicate with terminals can be performed by radio base stations, one or more network nodes (for example, MMEs (Mobility Management Entities), S-GW (Serving-Gateways), and so on may be possible, but these are not limiting) other than radio base stations, or combinations of these.

The respective aspects/embodiments illustrated in this specification may be used individually or in combinations, which may also be switched and used during execution. The order of processes, sequences, flowcharts and so on of the respective aspects/embodiments described in the present specification may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to systems that use LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Wireless Access), New-RAT (Wireless Access Technology), NR (New Wireless), NX (New wireless access), FX (Future generation wireless access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark) and other adequate wireless communication methods, and/or next-generation systems that are enhanced based on these.

The phrase “based on” as used in this specification does not mean “based only on”, unless otherwise specified. In other words, the phrase “based on” means both “based only on” and “based at least on.”

Any reference to elements with designations such as “first”, “second” and so on as used herein does not generally limit the number/quantity or order of these elements. These designations are used only for convenience, as a method of distinguishing between two or more elements. In this way, reference to the first and second elements does not imply that only two elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database or some other data structure), ascertaining and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

As used herein, the terms “connected” and “coupled”, or any variation of these terms, mean all direct or indirect connections or coupling between two or more elements, and may include the presence of one or more intermediate elements between two elements that are “connected” or “coupled” to each other. The coupling or connection between the elements may be physical, logical or a combination of these. For example, “connection” may be interpreted as “access.” As used herein, two elements may be considered “connected” or “coupled” to each other by using one or more electrical wires, cables and/or printed electrical connections, and, as a number of non-limiting and non-inclusive examples, by using electromagnetic energy, such as electromagnetic energy having wavelengths in wireless frequency fields, microwave regions and optical (both visible and invisible) regions.

When terms such as “include”, “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1-12. (canceled)

13. A channel measurement method performed by a user terminal, including:
receiving port indication information which indicates measurement ports for resource elements in a common reference signal resource region, wherein one resource element in the common reference signal resource region is allocated with measurement ports respectively corresponding to one or more channel measurement types;
obtaining reference information transmitted by the resource elements in the common reference signal resource region, according to the port indication information;
processing the reference information according to channel measurement types corresponding to the measurement ports indicated by the port indication information.

14. The method of claim 13, wherein the processing the reference information according to channel measurement types corresponding to the measurement ports indicated by the port indication information includes:
when the port indication information indicates that one resource element is allocated with measurement ports corresponding to a plurality of channel measurement types, the reference information is respectively processed according to respective channel measurement types corresponding to the measurement ports.

15. The method of claim 13, further including:
receiving resource region indication information which indicates the common reference signal resource region, and
obtaining reference information transmitted by the resource elements in the common reference signal resource region, according to the resource region indication information.

16. The method of claim 13, further including:
receiving port adjustment information;
processing the reference information according to changed measurement types corresponding to the measurement ports indicated by the port adjustment information.

17. A radio base station including:
a transmitting unit configured to transmit port indication information which indicates measurement ports for resource elements in a common reference signal resource region, wherein one resource element in the common reference signal resource region is allocated with measurement ports corresponding to one or more channel measurement types, and
a processing unit configured to indicate the transmitting unit to transmit reference information to a user terminal by using the resource elements in the common reference signal resource region.

18. The radio base station of claim 17, wherein
the transmitting unit transmits initial port indication information to the user terminal, wherein the initial port indication information indicates a first measurement port which is initially allocated to the resource elements and corresponds to specific channel measurement types, or a second measurement port which is initially allocated to the resource elements and corresponds to pending channel measurement types; and
the transmitting unit also transmits supplemental port indication information to the user terminal, wherein the supplemental port indication information indicates a measurement type that is supplementally allocated to the second measurement port.

19. The radio base station of claim 17, wherein
the channel measurement types include channel measurement based on non-zero power channel state information reference signals (CSI-RSs), channel measurement based on zero power CSI-RSs, and/or channel measurement based on demodulation reference signals (DMRSs).

20. The radio base station of claim 19, wherein
when the user terminal is indicated to carry out channel measurement based on CSI-RSs, the supplemental port indication information indicates that the measurement type that is supplementally allocated to the second measurement port is the channel measurement based on non-zero power CSI-RSs or the channel measurement based on zero power CSI-RSs.

21. The radio base station of claim 19, wherein
when downlink shared channel transmission is carried out to the user terminal, the supplemental port indication information indicates that the second measurement port is supplementally allocated to the channel measurement based on DMRSs;
when the downlink shared channel transmission is not carried out to the user terminal, the supplemental port indication information indicates that the measurement type that is supplementally allocated to the second measurement port is the channel measurement based on non-zero power CSI-RSs or the channel measurement based on zero power CSI-RSs.

22. The radio base station of claim 17 or 18, wherein
the transmitting unit is further configured to transmit, to the user terminal, resource indication information which indicates uplink scheduling resources and/or downlink scheduling resources for the user terminal.

23. The radio base station of claim 22, wherein
when the resource indication information is used for the uplink scheduling resources and the downlink scheduling resources for the user terminal, the uplink scheduling resources are a part of the downlink scheduling resource.

24. The radio base station of claim 17, wherein
the transmitting unit is further configured to transmit resource region indication information which indicates the common reference signal resource region.

25. A user terminal including:
a receiving unit configured to receive resource region indication information which indicates a common reference signal resource region, and to receive port indication information which indicates measurement ports for resource elements in the common reference signal resource region, wherein one resource element in the common reference signal resource region is allocated with measurement ports respectively corresponding to one or more channel measurement types;
a processing unit configured to obtain, according to the resource region indication information and the port indication information, reference information transmitted by the resource elements in the common reference signal resource region, and to process the reference information according to channel measurement types corresponding to the measurement ports indicated by the port indication information.

26. The user terminal of claim 25, wherein
when the port indication information indicates that one resource element is allocated with measurement ports corresponding to a plurality of channel measurement types, the processing unit processes the reference information respectively according to respective channel measurement types corresponding to the measurement ports.

27. The user terminal of claim 25, wherein
the processing unit further configured to obtain reference information transmitted by the resource elements in the common reference signal resource region, according to the resource region indication information.

28. The user terminal of claim 25, wherein
the receiving unit further configured to receiving port adjustment information;
the processing unit further configured to process the reference information according to changed measurement types corresponding to the measurement ports indicated by the port adjustment information.
